(19) United States
(12) Patent Application Publication
(10) Pub. No.: US 2015/0039667 A1
(43) Pub. Date: Feb. 5, 2015

(54) INCREMENTAL PROCESSING ON DATA INTENSIVE DISTRIBUTED APPLICATIONS

(71) Applicant: LinkedIn Corporation, Mountain View, CA (US)

(72) Inventors: Samir M. Shah, San Francisco, CA (US); Matthew T. Hayes, Milpitas, CA (US)

(21) Appl. No.: 14/337,841

(22) Filed: Jul. 22, 2014

Related U.S. Application Data
(60) Provisional application No. 61/861,770, filed on Aug. 2, 2013.

(51) Int. Cl. H04L 29/08

(52) U.S. Cl. CPC H04L 67/10
USPC 709/201

(57) ABSTRACT

Disclosed in some examples are methods, machine readable mediums, and systems which build upon traditional frameworks such as Hadoop for developing incremental monoid computations. In some examples, the traditional frameworks requires no modifications, and may provide an accumulator-based interface for programmers to store and use state across successive runs; the framework may ensure that only the necessary sub-computations are performed and incremental state management may be hidden from the programmer.

### PRIORITY CLAIM

This patent application claims the benefit of priority, under 35 U.S.C. Section 119 to U.S. Provisional Patent Application Ser. No. 61/861,770, entitled “INCREMENTAL PROCESSING ON DATA INTENSIVE DISTRIBUTED APPLICATIONS,” filed on Aug. 2, 2013 to Samir M. Shah and Matthew T. Hayes, which is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright LinkedIn, Inc., All Rights Reserved.

### DETAILED DESCRIPTION

Large clusters of commodity hardware running special software frameworks are often used to process computationally intensive data analysis applications in a distributed manner. For example, Apache Hadoop, developed by the Apache Software Foundation, is one such framework. Hadoop enables processing of large data sets through the use of relatively easy-to-use semantics. Hadoop manages the nodes of the hardware clusters and distributes portions of the computations across the various nodes of the cluster for parallel execution.

Hadoop is often used to perform computing tasks using the MapReduce programming model. A MapReduce program defines a Map function that performs filtering and/or sorting and a Reduce function that performs a summary operation on the results of the Map function. Hadoop coordinates the execution of the MAP operations in parallel across a large number of computing nodes and the execution of the REDUCE operation on a smaller number of nodes to process the results of the MAP function.

The proliferation of Hadoop, with its relatively easy-to-use MapReduce semantics, has transformed common descriptive statistics and dashboarding tasks as well as large-scale machine learning inside organizations. For example, social networking services often utilize Hadoop for people, job, and other types of entity recommendations, ad targeting, news feed updates, analytical dashboards, and the like. One example of a descriptive statistic task may be to calculate daily a list of members who have not logged into a website in the past month. The simple implementation is to compute the set difference between the set of all members and the set of members that logged into the system over the past 30 days by devising a job to process the past 30 days of login event data every day. In this approach 30 days of data is processed every day even though 29 days of data was processed the preceding day. Similarly, in machine learning applications, an example of a feature may be impression discounting: dampening recommendations if they are seen but not acted upon. Again, the naive implementation is for a job to compute impression counts by re-reading and re-computing data from the beginning of the desired window of time—data that was already processed in previous runs.

Re-use of the previous calculations would result in computational savings. However, Hadoop and other software frameworks do not easily allow for saving or re-use of previously computed data due to the burdensome incremental state management for the programmer. This creates inefficiencies for tasks that could be computed incrementally.

Disclosed in some examples is a software framework which builds upon traditional software frameworks such as Hadoop for developing incremental monoid computations. In some examples, the distributed framework requires no modifications—e.g., it runs on unmodified Hadoop (or other frameworks), and may provide an accumulator-based interface for programmers to store and use state across successive runs; the framework may ensure that only the necessary sub-computations are performed and incremental state management may be hidden from the programmer. Example applications include dash boarding and machine learning.

The systems, methods, and machine readable mediums disclosed are designed to improve the efficiency of sliding-window computations for Hadoop systems. A sliding-window computation uses input data which is partitioned on some variable and reads only a subset of the data. What makes the window sliding is that the computation usually happens regularly and the window grows to include new data as it arrives. Often this variable is time, and in this case we say that the dataset is time-partitioned. The window thus grows to include additional data as the result of the passage of time. In this disclosure we focus on processing time-partitioned data, however, one of ordinary skill in the art will appreciate that the principles disclosed in the present disclosure extend beyond time partitioned data to any partition type.

Consider an example where a dataset consists of login events collected from a website where an event is recorded each time a user logs in and the event contains the user ID and time of login. These login events could be stored in a distributed file system in such a way that they are partitioned by day. For example, there may be a convention that all login events for a particular day are stored under the path: /data/login/yyyy/mm/dd. With a partitioning scheme such as this it is possible to perform computations over date ranges. For example, a job may run daily and compute the number of logins which occurred in the past 30 days. The job only needs to consume 30 days' worth of data instead of the full data set.

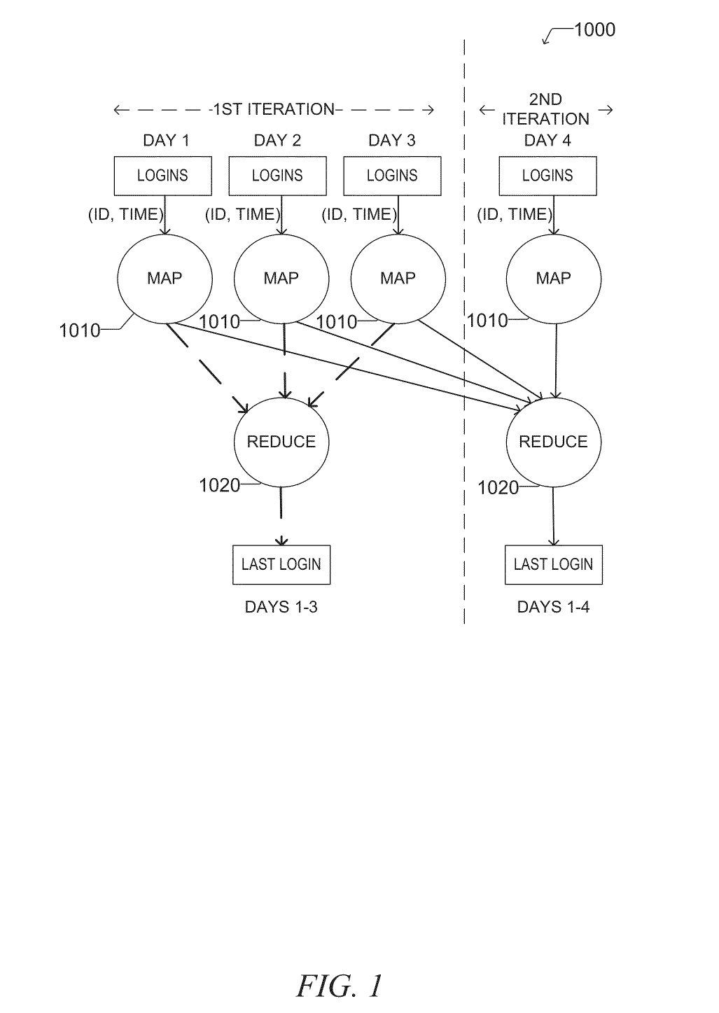

Suppose that the last login time for each user was required. FIG. 1 presents two iterations of a MapReduce job 1000 producing this information from the login event data. Without loss of generality, the view is simplified such that there is one map task 1010 per input day and one reduce task 1020 per block of output. The input data is partitioned by day. Each map task (M) 1010 extracts pairs (ID,login) representing each login event by a user. The reducer (R) 1020 receives pairs grouped by user ID and applies max( ) to the set of login times, which produces the last login time for each user over the time period. The reducers outputs these last login times as (ID,last login) pairs. The first iteration consumes days 1-3 and produces the last login time per user for that period. The second iteration begins when day 4 data is available, at which point it consumes all 4 days of available data again. Consecutive days share much of the same input data. Computing the last login time in this way is an example of what is called an append-only sliding window problem. In this case the start of the window is fixed and the end grows as new data becomes available. As a result the window length is always increasing.

One inefficiency present in this job is that each iteration consumes data which has already been processed previously. The MAP task 1010 for days 1-3 are performed again during the second iteration. If the last login time per user is already known for days 1-3, then this result could be used in place of the input data for days 1-3. This would be more efficient since the output data is smaller than the input data. It is this type of inefficiency which the present disclosure addresses.

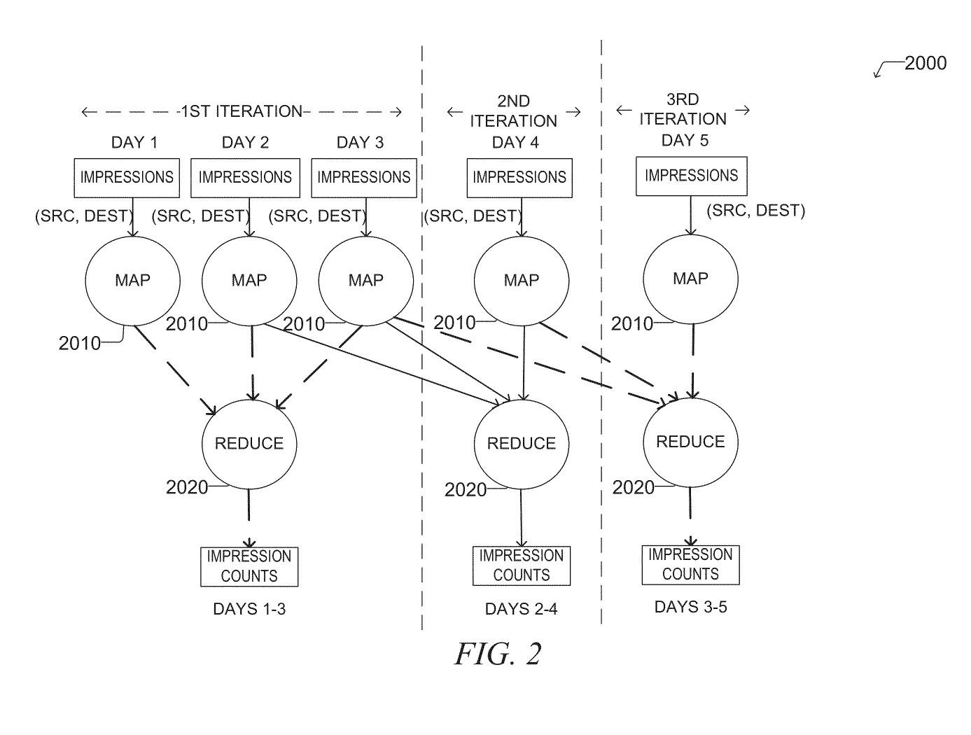

As another example, suppose there is a recommendation system which recommends items to users. Each time items are recommended to a user the system records an event consisting of the member ID and item IDs. Impression discounting is applied in order to improve the diversity of recommendations, a method by which recommendations with repeated views are demoted in favor of unseen ones. With this in mind, FIG. 2 presents three iterations of a MapReduce job 2000 computing the impression counts for the last three days. This is similar to the last-login case of FIG. 1 except that the input window is limited to the last three days instead of all available data. Computing the impression counts in this way is an example of what we will call a fixed-length sliding window problem. For this type of problem the length of the window is fixed. The start and end of the window both advance as new data becomes available.

FIG. 2 shows an example 2000 of computing (src,dest) impression counts over a three day sliding window using MapReduce. The input data is partitioned by day. Each Map task 2010 extracts (src,dest) pairs from its input data. The Reducer 2020 counts the number of instances of each (src,dest) pair and outputs (src,dest,count). The first iteration consumes days 1-3 and produces counts for that period. The second iteration begins when day 4 data is available, at which point it consumes the most recent 3 days at this time, which are days 2-4. When day 5 data is available the third iteration executes, consuming days 3-5. Consecutive days share much of the same input data.

As with the previous example, the impression counting job presented in FIG. 2 is inefficient because the output of the previous iterations are not reused. There is significant overlap of the input data consumed by consecutive executions of the job. The overlap becomes greater for larger window sizes. The inefficiencies presented here are at the core of what the present disclosure attempts to address. The challenge is to develop a programming model for solving these problems efficiently which does not burden the developer with complexity.

Some of the design parameters for the disclosed software framework include the following: Portability: the software framework is usable in a standard distributed processing system such as a Hadoop system without changes to the grid infrastructure or architecture. In other words, it uses out-of-the-box components without external dependencies on other services or databases.

Minimize Total Task Time: The total task time refers to the sum of the execution times of all Map and Reduce tasks. This represents the compute resources used by the job. A Hadoop cluster has a fixed number of slots which can execute Map and Reduce tasks. Minimizing total task time therefore means freeing up slots for other jobs to use to complete work. Some of these jobs may even belong to the same workflow. Minimizing total task time therefore can contribute to greater parallelism and throughput for a workflow and cluster.

Minimize Execution Time: The execution time refers to the wall clock time elapsed while a job completes. This should include all work necessary to turn input data into output data. For example, the presently disclosed software framework may produce intermediate state to help it process data more efficiently. A MapReduce job producing such intermediate state would be included here. While minimizing job execution time is a goal, in some cases it may be worth trading off slightly worse wall clock time for significant improvements in total task time. Likewise wall clock time for an individual job may be worse but the overall wall clock time of a workflow may be improved due to better resource usage.

Efficient Use of Storage: The solution described in the present disclosure may require additional storage in the distributed file system to make processing more efficient. There are two metrics which we should be concerned with: total number of bytes and total number of files. The number of files is important because the Hadoop distributed file system maintains an index of the files it stores in memory on a master server, the NameNode. Therefore it is not only a goal to minimize the additional bytes used but also the file count.

### Append-Only Sliding Window

First the concept of a partition-collapsing job is introduced. The partition-collapsing job reads partitioned data as input and merges the data together, producing a single output. For example, a job may read the last 30 days of day-partitioned data and produce a count per key which reflects the entire 30 day period.

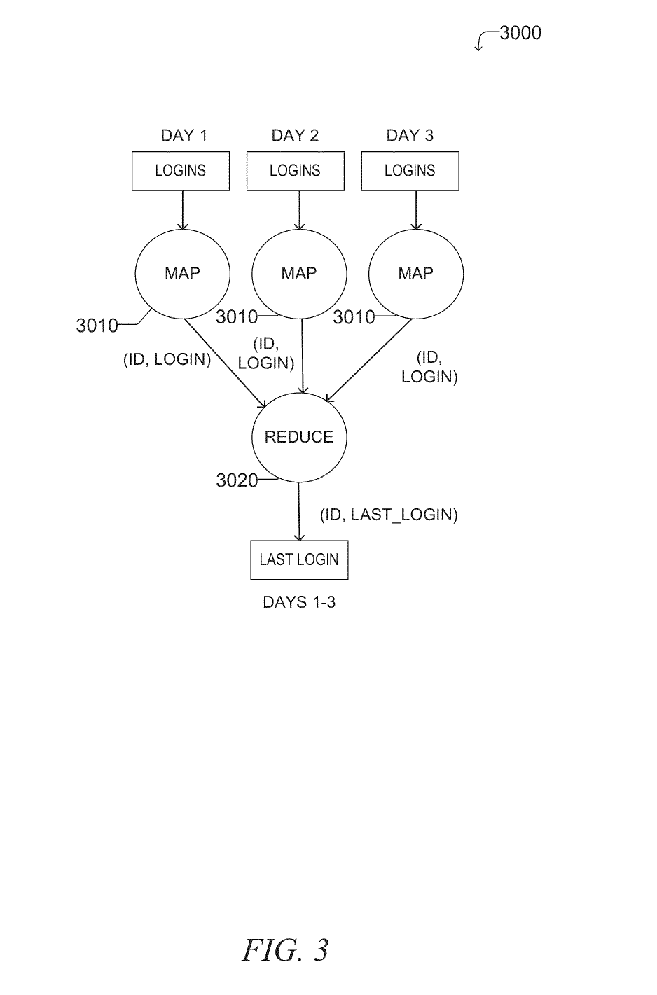

FIG. 3 presents an example of a partition-collapsing job 3000. Here three consecutive blocks of data for three consecutive days have been collapsed into a single block. The job consumes three consecutive days of day-partitioned input data and produces a block of output data spanning those three days. This particular job consumes login events partitioned by day. Each Map task 3010 outputs (ID,login) pairs representing the time each user logged in. The Reducer 3020 receives a set of login times for each ID and applies max( ) to determine the last login time for each user, which it outputs as (ID,last login) pairs. The job has therefore collapsed three consecutive day-partitioned blocks of data into a single block representing that time span.

More formally, a partition-collapsing job takes as input a set of time-consecutive blocks I^{[t1,t2)}, I^{[t2,t3)}, . . . , I^{[tn-1,tn)} and produces output O^{[t1,tn)}, where tᵢ<tᵢ+1. In FIG. 3 blocks I^{[1,2)}, I^{[2,3)}, I^{[3,4)} are processed and O^{[1,4)} is produced.

FIG. 3 can be used for the append-only sliding window problem, but it is inefficient. One of the fundamental weaknesses is that each execution consumes data which was previously processed. Suppose that the Reduce step can be represented as a sequence of binary operations on the values of a particular key: a⊕b⊕c⊕d. Assuming the Reducer processes these values in the order they are received then the operation can be represented as (((a⊕b)⊕c)⊕d). However if the data and operation have the associativity property then the same result could be achieved with (a⊕b)⊕(c⊕d). This means that one Reducer could compute (a⊕b), another Reducer could compute (c⊕d), and another Reducer could apply ⊕ to the two resulting values. If the intermediate results are saved then the computations do not need to be repeated. When new data e arrives, we can compute (a⊕b)⊕(c⊕d) ⊕e without having to recompute (a⊕b) and (c⊕d).

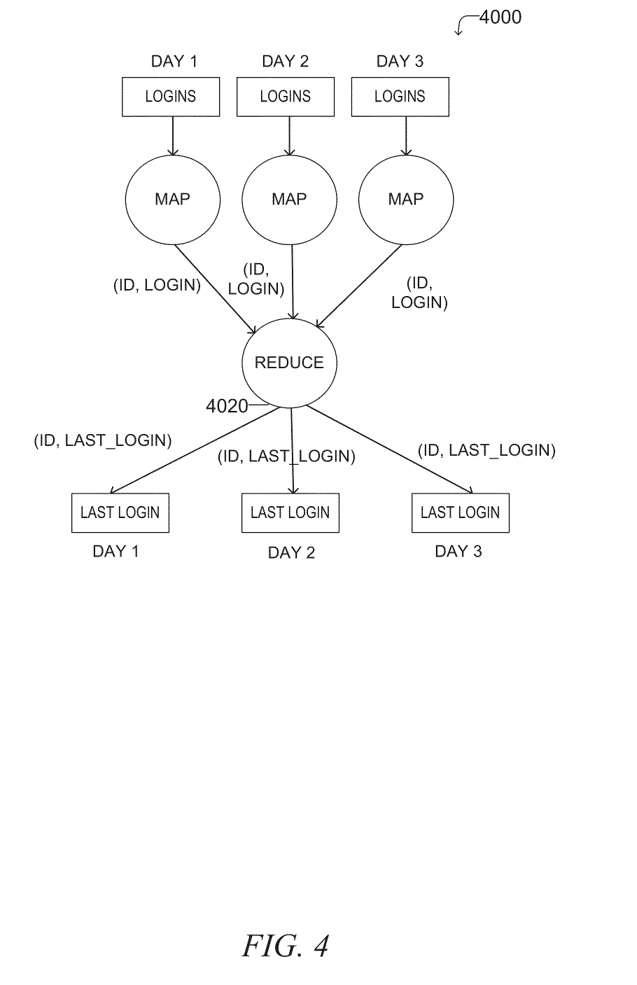

An example of a job applying this principle is presented in FIG. 4. FIG. 4 is referred to as a partition-preserving job 4000. Here the Reducer 4020 maintains the partitions from the input data as it applies the Reduce operation. As a result the output is partitioned by day as well. This achieves the same result as running a separate MapReduce job on each day of input without the scheduling overhead. The job consumes three days of day-partitioned input data and produces three days of day-partitioned output data. Here the Reducer 4020 keeps the input data partitioned as it applies the reduce operation. As a result the output is partitioned by day as well. The (ID,last login) pairs for a particular day of output are only derived from the (ID,login) pairs in the corresponding day of input.

More formally, a partition-preserving job takes as input a set of time-partitioned blocks I^{[t1,t2)}, I^{[t2,t3)}, . . . , I^{[tn-1,tn)} and produces time-partitioned output O^{[t1,t2)}, O^{[t2,t3)}, . . . , O^{[tn-1,tn)}, where O^{[ti,tj)} is derived from I^{[ti,tj)}.

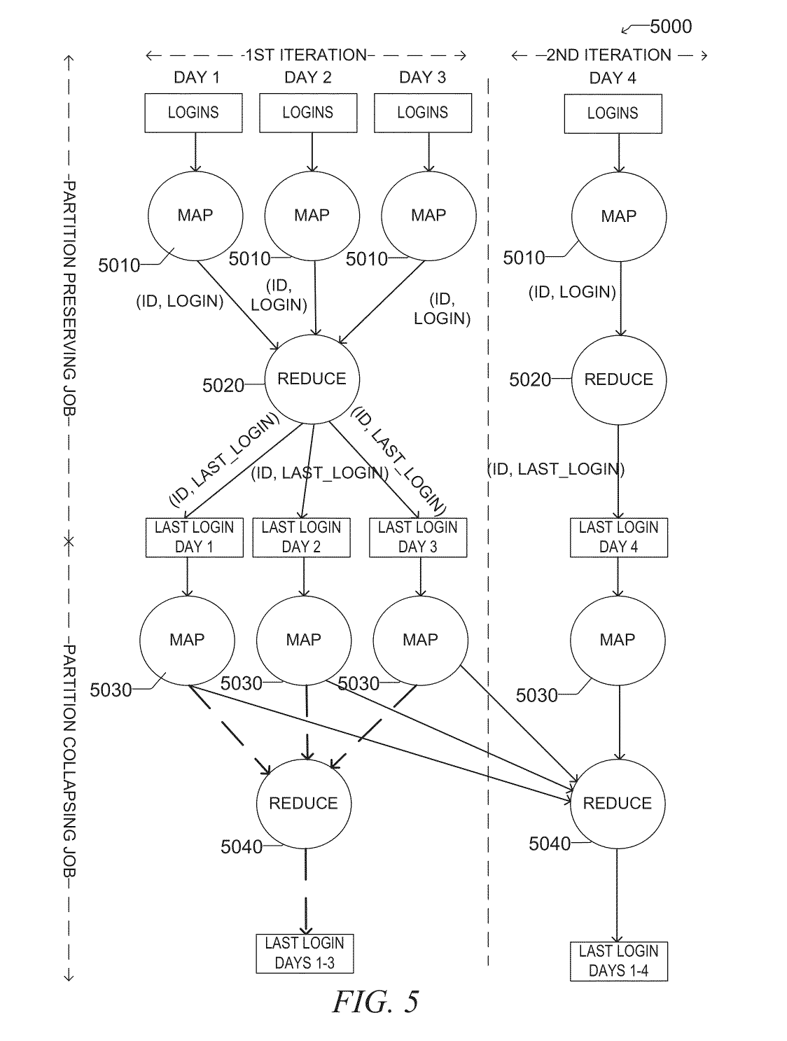

Partition-preserving jobs provide one way to address the inefficiency of the append only sliding window problem presented in FIG. 1. Assuming the last login times are first computed for each day as in FIG. 4, the results can serve as a substitute for the original login data. This idea is presented in FIG. 5.

FIG. 5 shows an example of an append-only sliding window computation 5000 of the last login time per user through the use of a partition-preserving job followed by a partition collapsing job. The first job's Map task 5010 reads login events from day partitioned data and outputs (ID,login) pairs representing the login times for each user. The Reducer 5020 receives the login times per user but maintains their partitioning. It computes the last login time for each day separately, producing day-partitioned output. The second job's Map task 5030 reads in the last login time for each user for each of the days being consumed and sends the (ID,last login) to the Reducer 5040 grouped by ID. The Reducer 5040 applies max( ) to the login times to produce the last login time over the period. For the first iteration, the first pass processes three days of input data and produces three days of intermediate data. For the second iteration it only processes one day of input data because the previous three have already been processed. The second pass for the second iteration therefore consumes one block of new data and three blocks which were produced in a previous iteration.

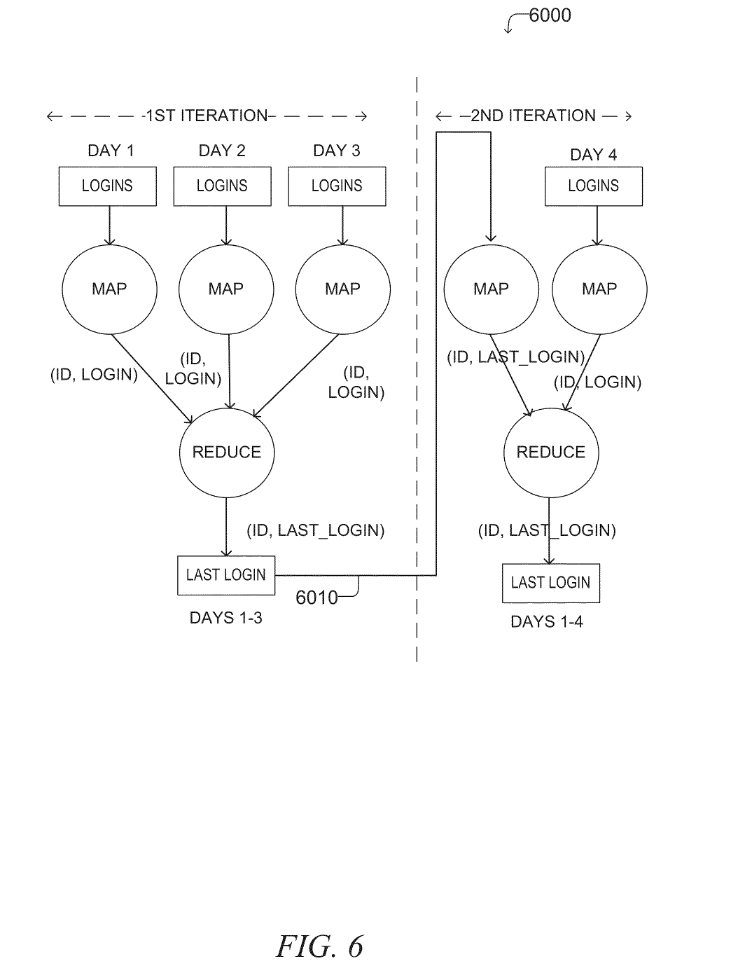

One interesting property of the last-login problem is that the previous output can be reused. For example, given output O^{[ti-1,ti)}, the output O^{[ti,ti+1)} can be derived with just I^{[ti,ti+1)}. FIG. 6 shows an example of a partition-collapsing job 6000 solving the append-only sliding window problem by reusing previous output 6010. Here the first iteration has already produced the last login times for each user for days 1-3. The second iteration uses this output 6010 instead of consuming the input data for days 1-3. This has two advantages over the previous two-pass version. First, the output data should be smaller than both the input data and the intermediate data, so it should be more efficient to consume the output in place of either. Second, it avoids scheduling overhead and increased wall clock time from having two sequentially executed MapReduce jobs.

Two techniques have been presented for solving the append-only sliding window case more efficiently. One uses a sequence of two jobs, where the first is partition-preserving and the second is partition-collapsing. The second uses a single partition-collapsing job with feedback from the previous output.

### Fixed-Length Sliding Window

Similar to the append-only sliding window case, this problem can be solved using a sequence of two jobs, the first partition-preserving and the second partition-collapsing. The idea is no different here except that the partition-collapsing job only consumes a subset of the intermediate data. This has the same benefits as it did for the append-only sliding window problem. For append-only sliding windows it was shown that in some cases it is possible to apply an optimization where only the single partition-collapsing job is used. If the previous output can be reused then the partition-preserving job can be dropped. In some cases a similar optimization can be applied to fixed-length sliding windows.

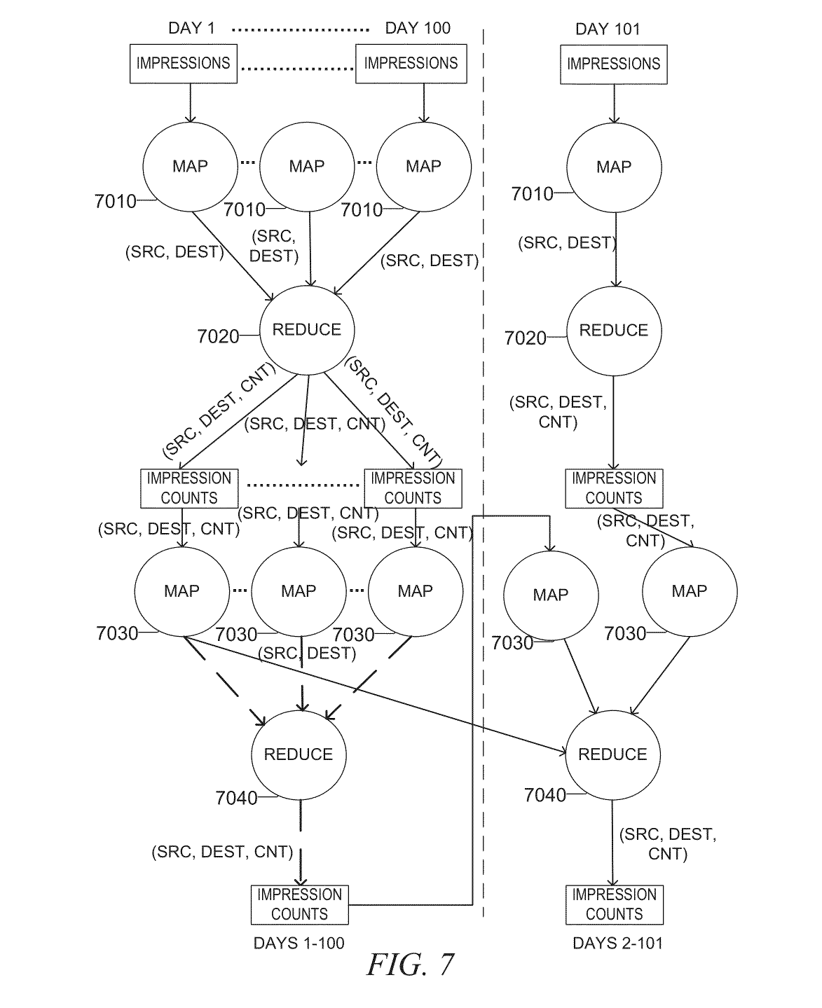

The idea is presented in FIG. 7 for a 100 day sliding window on impression counts. Here the previous output is used and combined with the newest day of intermediate data, however in addition the oldest day which the previous output was derived from is also consumed so that it can be subtracted out. This still requires two jobs, but the partition-collapsing job consumes far less intermediate data.

FIG. 7 shows an example of a 100 day sliding window computation of impression counts through the use of a partition preserving job followed by a partition collapsing job. The first job's Map task 7010 reads impressions from day-partitioned data and outputs (src,dest) pairs representing instances of src being recommended dest. The Reducer 7020 receives these grouped by (src,dest). It maintains the partitioning and computes the counts of each (src,dest) separately per day, producing day partitioned output. For the first iteration the second pass consumes 100 days of intermediate data. Each Map task 7030 outputs (src,dest,cnt) pairs read from the intermediate data. The Reducer 7040 receives these grouped by (src,dest) and sums the counts for each pair, producing (src,dest,cnt) tuples representing the 100 day period. For the second iteration the first pass only needs to produce intermediate data for day 101. The second pass consumes this new intermediate data for day 101, the intermediate data for day 1, and the output for the previous iteration. Because these are counts, arithmetic can be applied to subtract the counts from day 1 from the counts in the previous output. This is possible because the Reducer from the first job maintains the data partitions (so the system knows which data relates to day 1). The result is the counts for days 2-100. Adding the counts from the intermediate data for day 101 results in the counts for days 2-101.

### Programming Model

One of the goals of the present disclosure is to provide a simple programming model that enables a developer to construct an incremental workflow for sliding window consumption without having to be concerned with the complexity of implementing an incremental system. The previous section showed that it is possible to solve append-only and fixed-length sliding window problems using two types of jobs:

Partition-preserving job: This job consumes partitioned input data and produces output data having the same partitions. The Reduce operation is therefore performed separately on the data derived from each partition so that the output has the same partitions as the input.

Partition-collapsing job: This job consumes partitioned input data and produces output which is not partitioned, the partitions essentially being collapsed together. This is similar to a standard MapReduce job, however the partition-collapsing job can reuse its previous output to improve efficiency.

Consider some of the implications these features have on the Mapper. In order for the Reducer of the partition-preserving job to maintain the same partitions for the output, some type of identifier for the partition must be included in the key produced by the Mapper. For example, an impression (src,dest) would have a key (src,dest,pid), where pid is an identifier for the partition from which this (src,dest) was derived. This ensures that reduce only operates on (src,dest) from the same partition. Regarding the partition-collapsing job, it can reuse its previous output, which means that the previous output has to pass through the Mapper. The Mapper therefore has to deal with two different data types.

There are implications for the Reducers too. For the partition-preserving job, the Reducer must write multiple outputs, one for each partition in the input data. For the partition-collapsing job, the Reducer must not only perform its normal reduce operation but also combines the result with the previous output. The present disclosure hides these details from the developer so they can focus on the core logic, as would normally express in a standard MapReduce job. It achieves this by making some changes to the MapReduce programming model.

First the MapReduce programming model can be expressed functionally as:
Map: (v₁)→[(k,v₂)]
Reduce: (k, [(v₂)])→[(v₃)]

The Map takes a value of type v₁ and outputs a list of intermediate key-value pairs having types k and v₂. The Reduce function receives all the values for a particular key and outputs a list of values having type v₃.

One example pseudo-code implementation for counting (src,dest) impressions using MapReduce may include:

| | |
|---|---|
| function MAP(impr) | |
| EMIT(impr,1) | [symbol] impr ≡ (src,dest) |
| end function | |
| function REDUCE(impr,counts) | |
| sum ← 0 | |
| for c in counts do | |
| sum = sum+c | |
| end for | |
| output ← (impr.src,impr.dest,sum) | |
| EMIT(output) | |
| end function | |

In this example, the map function emits (src,dest) as the key and 1 as the value. The reduce function is iterator based and receives the values grouped by each (src,dest) and simply sums them to arrive at the total number of impressions for each (src, dest) and emits (src,dest,count).

This example uses an iterator-based interface for the reduce implementation. In this approach an interface representing the list of values is provided to the user code. The user code then iterates through all values present in the list. An alternative to this is the accumulator-based interface, which has the same expressiveness as the iterator-based interface. An example of the accumulator-based approach for example may be:

function INITIALIZE( )
return 0
end function
function ACCUMULATE(sum,impr,count)
return sum+count
end function
function FINALIZE(impr,sum)
output← (impr.src,impr.dest,sum)
EMIT(output)
end function

To sum the counts for a particular (src,dest) pair, first initialize is called to set the initial sum to zero. Then accumulate is called for each count emitted by the mapper, where for each call the current sum is passed in and a new sum is returned. When all counts have been processed the final sum is passed to the finalize method, which emits the output.

Next we will present how the programming model differs in the present disclosure. In some examples, the framework may add constraints on the programming model. One example constraint may be to require an accumulator-based interface for the Reduce implementation. Additionally the functional expression of Reduce is slightly different from that of general MapReduce:
Map: (v₁)→[(k,v₂)]
reduce: (k, [(v₂)])→(k,v₃)
   The Map function here is the same as in the MapReduce programming model. The Reduce function is constrained such that it is less general than the MapReduce definition. For one key, at most one value can be produced by the reducer. In some examples, the key k may be implicitly included in the output of the reducer by the presently disclosed software framework so the user code only needs to return the output value. For these examples, finalize does not need to return the src and dest values because they will implicitly be paired with the return value. An example of a finalize implementation may be:

function FINALIZE(impr,sum)
return sum
end function

The Map operation defined by the user, in some examples, retains the same functional definition because the presently disclosed software framework hides the underlying details from the user. For example, the mapper defined by the user is only invoked on the input data, not the previous output. The software framework presently disclosed ensures that the Mapper for the partition-collapsing job passes the previous output to the Reducer—all without user code being involved. Likewise the Mapper for the partition-preserving job attaches the partition identifier to the output of the user's Map function before sending it to the Reducer. From the user's perspective, there is no difference in the operation of the Map function.

The Reduce operation differs because the partition-collapsing job is more efficient if it reuses the previous output. Reusing the previous output implies that it must pass through the Mapper. By forcing the output of the Reduce operation to be in the form (key,value), it is possible to pass the data through the mapper without the developer having to implement any custom code. Otherwise the developer would have to implement a Map operation for the previous output as well, making the implementation more complicated and exposing more of the underlying details of the incremental code. This conflicts with the goal of having a simple programming model. This differs from the traditional MapReduce model in that it sacrifices generality for a simple programming model that supports all the incremental use cases.

To reuse the previous output, the software framework presently disclosed may require, in some examples, that a Merge operation be implemented if it is an append-only sliding window job. For the fixed-length sliding window job it in addition requires, that an unmerge operation be implemented.
merge: (v3,v3)→(v3)
unmerge: (v3,v3)→(v3)

These functions take two parameters of type v₃, the output value type of the reducer function. Merge combines two output values together. Unmerge effectively is an undo for this operation. Given an output value it can subtract another output value from it.

One example of merge for the last login problem described previously may include:

function MERGE(prev_last_login, new_last_login)
last_login = max(prev_last_login,new_last_login)
return last_login
end function

Given the previous last login and the last login for the new set of data just processed, it computes the max of the two and outputs this as the new last login.

One example of merge and unmerge for computing impression counts may be:

function MERGE(prev_count,new_count)
curr_count = prev_count +new_counts
return curr_count
end function
function UNMERGE(prev_count, old_count)
curr_count = prev_count − old_counts
return curr_count
end function

Given the previous output count and the count from the new intermediate data, merge sums them to produce a new count. Given this count and the oldest intermediate count corresponding to the previous window, unmerge will subtract the latter from the former to produce the count over the new window.

### Capabilities

The software framework of the present disclosure can be used to incrementalize a wide class of sliding window problems. Recall that sliding window problems have the property that the input data is partitioned and the computation is performed on a consecutive sequence of these partitions. We can express the reduce operation as reduce(xᵢ [symbol] xᵢ₊₁ [symbol] . . . [symbol] xⱼ), where xᵢ is the list of map output data derived from one of the input partition and [symbol] represents concatenation. If the reduce operation can be represented as an associative binary operation ⊕ on two data elements of type M, then the previous reduce computation can be replaced with the equivalent reduce(xᵢ)⊕ reduce(xᵢ₊₁)⊕ . . . ⊕ reduce(xⱼ). Assuming that ⊕ has the closure property and that there also exists an identity element i_{⊕}, then together (M,⊕) form a monoid.

Splitting the reduce operation in this way translates directly to the first and second passes described earlier in the present disclosure, where the first pass is partition-preserving and the second pass is partition-collapsing. In some examples, the first pass produces partial results and saves these as intermediate data. The second pass computes the final result from the intermediate data. A binary operation ⊕ with identity i_{⊕} is easily expressible using an accumulator based interface. Therefore if the reduce operation for a sliding-window problem can be represented using a monoid then it can be incrementalized as two passes with the software framework of the present disclosure.

Either type of sliding-window problem can be incrementalized this way. There are many problems which can be expressed using monoid structures. For example, integers together with any of the operations min, max, addition, and multiplication form monoids. Average can also be computed using a monoid structure. There are also many approximation algorithms which can be implemented using monoid structures, such as Bloom filters, count-min sketches, and hyperloglog counters.

Assuming the reduce operation can be represented as a monoid consisting of (M,⊕), then the merge operation described earlier can also be represented using the same monoid with binary operation ⊕. This means that an append-only sliding window job may be implemented with just a single partition-collapsing job, as merge enables reuse of the previous output, making intermediate state unnecessary.

Recall that for the fixed-length sliding window, the second pass partition-collapsing job in some examples can only reuse the previous output if an unmerge operation is implemented. Unfortunately having the monoid property does not by itself mean that the unmerge operation can be implemented. However if the monoid also has the invertibility property, then the monoid is actually a group and unmerge can easily be implemented from merge by inverting one of the two elements. For example, for addition of integers we can define merge(x,y)→x+y. Using the invertibility property, we can define unmerge(x,y)→x−y. Therefore if the reduce operation for a fixed-length sliding window problem can be represented using a group, the problem can not only be incrementalized using two passes but the second pass partition-collapsing job can reuse the previous output.

Addition and multiplication of integers and rational numbers form a group. It is also possible to compute average using a group structure. This makes the software framework of the present disclosure well suited for certain counting and statistics jobs operating over fixed-length sliding windows.

### Evaluation

Two benchmarks were used to evaluate the performance of the software framework of the present disclosure. The first evaluated a fixed-length sliding window for a recommendation training set from the Weibo social networking service on a local single-machine Hadoop 1.0.4 installation. The second evaluated a fixed-length sliding window for impression data collected on the LinkedIn website for the “People You May Know” (PYMK) feature, which recommends connections to members. This benchmark was run on a Hadoop 1.0.4 grid at LinkedIn having hundreds of machines. Two metrics were collected. The first was total task time, which we defined as the sum of the execution time of all map and reduce tasks. This metric is important because it represents the amount of compute resources used by the job. A cluster has a fixed number of map and reduce slots which can execute tasks. Therefore reducing total task time for a job improves overall cluster throughput, enabling it to complete more work with the same amount of resources. The other metric collected was wall clock time, which we defined as the execution time of the job from setup start time to cleanup finish time. Since the software framework of the present disclosure uses a first and second pass for fixed-length sliding windows the metrics for the two passes were summed together.

4.1 Weibo Benchmark

The Weibo recommendation training data consists of a set of (UserId,ItemId,Result,Timestamp) tuples. The timestamp was used to partition the data by day and records consisting of (UserId,ItemId,Timestamp) were produced. This data was partitioned according to the path naming convention yyyy/mm/dd. This resulted in data ranging from 2011/10/11 to 2011/11/11.

The task for this benchmark was to count (src,dest) pairs over various fixed-length sliding windows. 7, 14, 21, and 28 day sliding windows were chosen. A basic MapReduce job was implemented so we could have a baseline to compare against. The map task produced a key (src,dest) and value (1) for each record. The reducer simply counted the number of values for each (src,dest) pair, producing (src,dest,count) records for the output.

Two types of jobs were implemented using the software framework of the present disclosure, one which reused output and one which did not. The first pass for each was the same. Like the baseline MapReduce job the mapper produced a key (src,dest) and value (1). Its implementation appears below. Similarly, the reducer output was (src,dest,count). The accumulator implementation for the combiner and reducer which perform the summation is also shown below. The second pass of both jobs simply summed the counts for each (src,dest) pair and output the resulting (src,dest,count).

(a)
public static class Mapper extends AbstractMapper {
private final GenericRecord key, value;
public Mapper( ) {
key = new GenericData.Record(KEY_SCHEMA);
value = new GenericData.Record(VALUE_SCHEMA);
value.put(“count”, 1L);
}
public void map(GenericRecord record,
KeyValueCollector collector)
throws IOException, InterruptedException {
key.put(“src”, (Long)record.get(“userId”));
key.put(“dest”,(Long)record.get(“itemId”));
collector.collect(key, value);
}
}
(b)
public static class Counter implements Accumulator {
private long count;
public void accumulate(GenericRecord value) {
count += (Long)value.get(“count”);
}
public boolean finalize(GenericRecord newValue) {
if (count > 0) {
newValue.put(“count”, count);
return true; // true means output record
}
return false; // false means do not output record
}
public void cleanup( ) {
this.count = 0L;
}
}

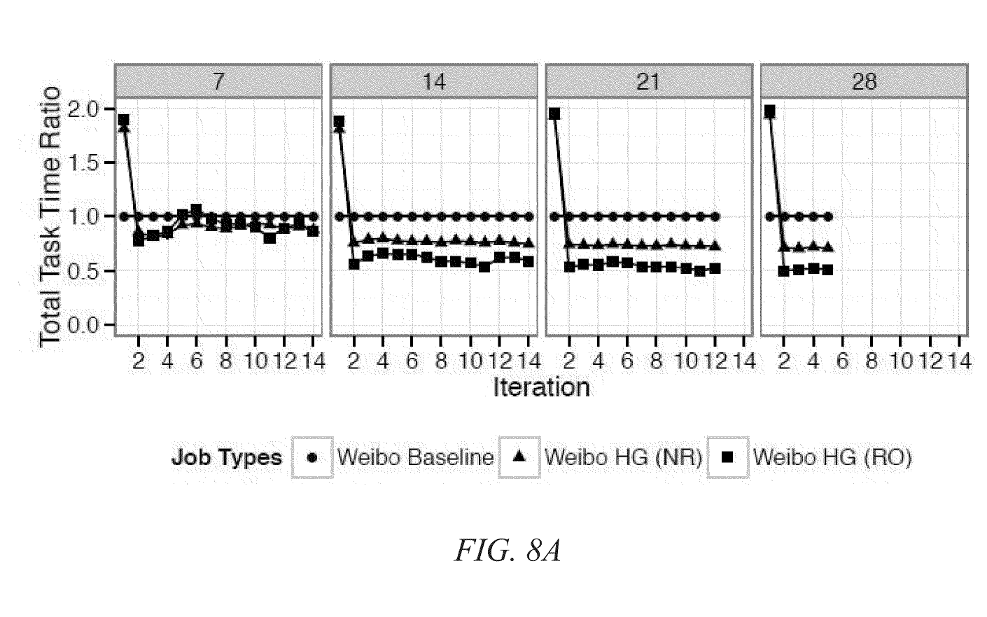

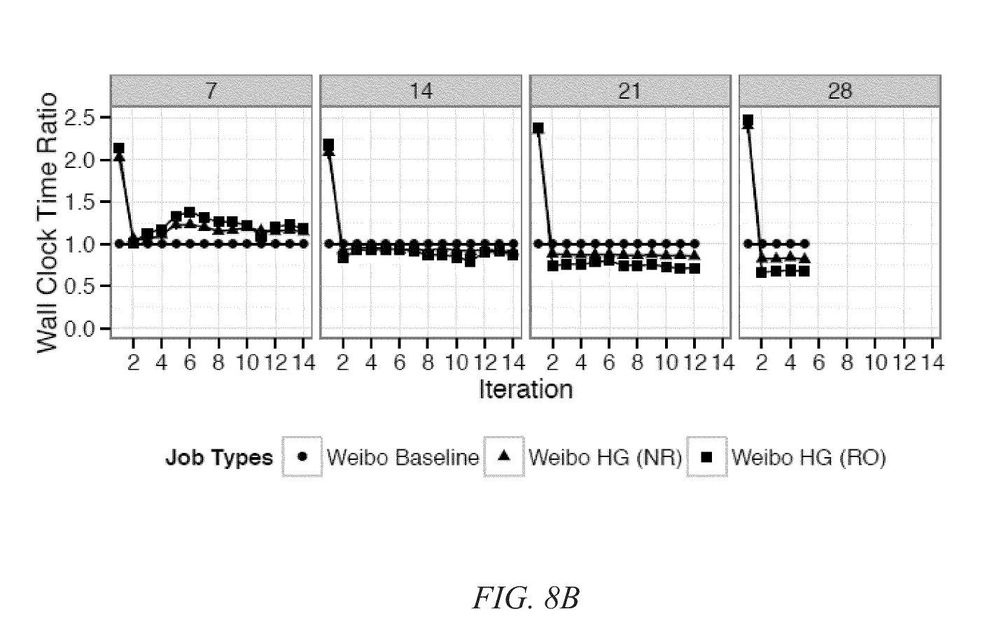

FIGS. 8A and 8B compare (a) the total task time, and (b) the total wall clock time of two jobs of the presently disclosed software framework against a baseline MapReduce job for the Weibo task. Values have been normalized against baseline. One job of the presently disclosed framework reuses the previous output (RO) and the other job does not (NR). Fixed-length sliding windows of 7, 14, 21, and 28 days are shown. In each case the total task time for the initial run is high due to generation of the intermediate state by the first pass job. Total task time for subsequent runs drops significantly. For the 28 day window the job which reuses previous output only uses about 50% of the total task time that the baseline job does. The job which does not reuse previous output uses about 70% of the total take time. As for the wall clock time, for a 28 day window the job which reuses previous output has about 67% of the wall clock time of the baseline job. The job which does not reuse previous output has about 82% of the wall clock time of baseline.

FIG. 8A presents a comparison of the total task time across multiple iterations for the three jobs as the window was advanced forward one day at a time. For the jobs of the software framework of the present disclosure an iteration includes a run of the first and second pass. The number of reducers was fixed at 1. For each iteration the job was run three times and the resulting values were averaged. While for the 7 day window the jobs of the currently disclosed software framework are sometimes better, sometimes worse, for the larger window lengths the jobs of the currently disclosed software framework consistently perform better. There is a trend of reduced total task time as the window length increases. The job which reuses the previous output performs best, yielding a further 20% reduction on top of the 30% reduction already achieved for the 28 day window. The total task time for the first iteration is substantially larger than the baseline case, reflecting the upfront cost of generating the intermediate per-day aggregates. For the 28 day window it is nearly 2× the total task time of baseline.

FIG. 8B presents a comparison of the wall clock time for the three jobs across multiple iterations. While the wall clock time is worse for the 7 day window, it improves for the 14 day window and continues to improve as the window size increases. For a 28 day window the wall clock time is reduced to 67% for the job reusing previous output and 82% for the one which does not.

Using the software framework of the present disclosure slightly more than doubles the storage space required for a given piece of output data. This is due to having to store the intermediate per-day aggregates. This intermediate data ranges in size from 110% to 125% of the final output. Part of the reason the wall clock time is so much lower for the jobs using the software framework of the present disclosure has to do with availability of cluster resources. In the local setup only two map tasks could run concurrently. This means any additional map tasks had to wait. The input data was day partitioned, and this resulted in one file per day of input. Because a multiple input format was not used, this meant that one map task was required per day. The baseline MapReduce job therefore required one map task per day in the sliding window. The first pass job according to the disclosed software framework however only needed one map task total for subsequent runs because each time only one day needed to be processed. This is evident when comparing the wall clock times of the first pass to baseline. The first pass finishes in 10% of the wall clock time of baseline. The second pass wall clock time is 57% of the baseline's.

### Impressions Benchmark

“People You May Know” (PYMK) at LinkedIn is a recommendation system which suggests member connections. To improve the quality of its recommendations it tracks which suggestions it has shown to members. The task for this benchmark was to count (src,dest) impression pairs over a 30 day sliding window. The input data consists of (src,destIds) pairs partitioned by day. For example, src 1 viewing dest IDs 2, 3, and 4 could be represented as (1,(2,3,4)).

This task is very similar to the previous one. Therefore a similar design for the jobs seems reasonable. However it turns out that flattening the data into (src,dest) pairs is very expensive, as it increases the number of records. Therefore the baseline MapReduce job outputs records of the form (src,destCounts), where destCounts is a list of (dest,count) pairs. The mapper keeps the data grouped by src and outputs a destIds list for the value. A combiner simply concatenates lists of dest IDs together. For example, if the combiner received (1,(2,3,4)) and (1,(2,5,6)) it would produce (1,(2,3,4,2,5,6)). The reducer counts the dest IDs to produce the final output.

For the jobs written using the presently disclosed framework, two variations were created, V1 and V2. For each variation there was one version which reused previous output and one which did not. The first variation (V1) did not perform any count aggregation in the first pass. The combiner and reducer both grouped the dest IDs by src, similar to the baseline job's combiner. The first pass of this variation therefore output records of the form (src,destIds). The second pass then counted dest IDs and output records of the form (src,destCounts).

The second variation (V2) explored the impact of performing aggregation in the first pass. The first pass reducer in this case counts dest IDs, rather than producing a list of all dest IDs seen. Its output has the form (src,destIds,counts), where destIds and counts are simply arrays of values. This is just another way of representing a list of (dest,count) pairs. The motivation was that the two arrays can be ordered in such a way that the counts array values are in increasing order, which should yield better compression.

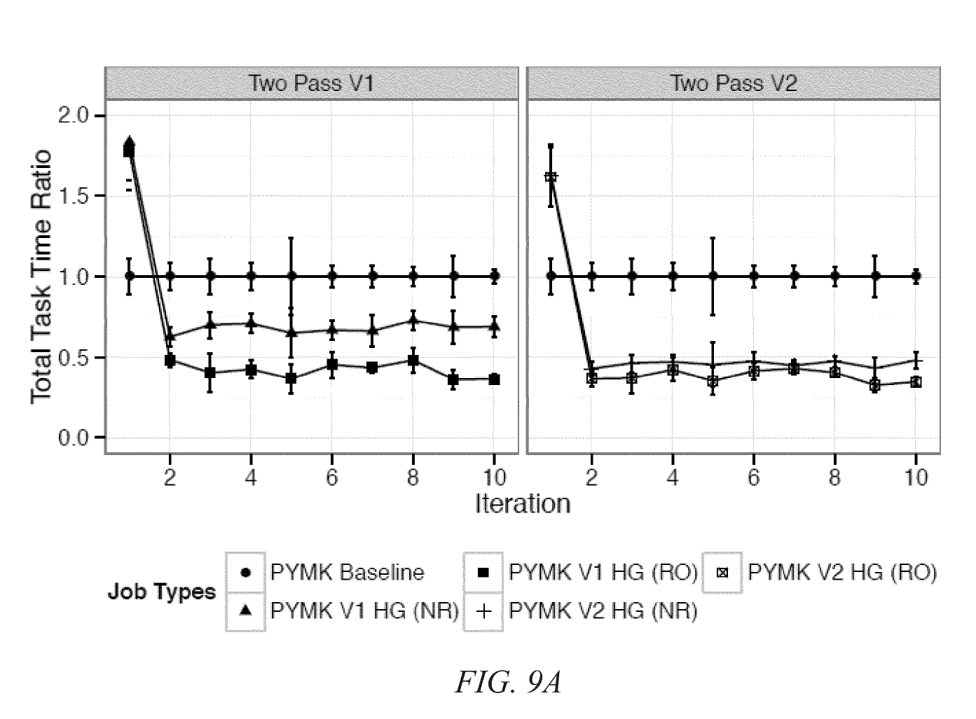

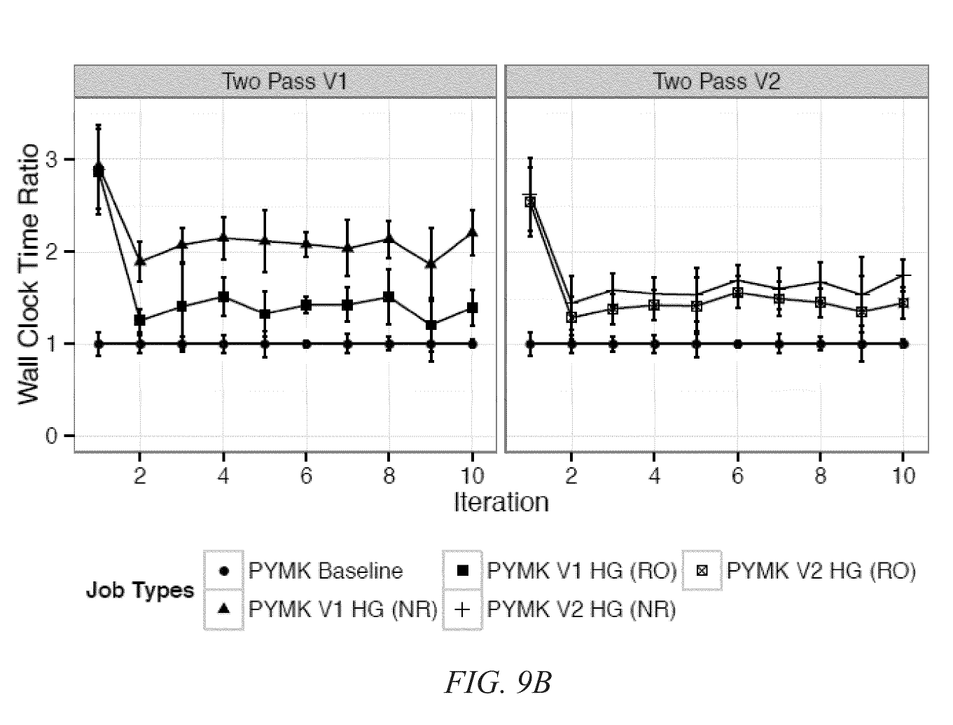

FIGS. 9A and 9B compares (a) the total task time, and (b) the total wall clock time for jobs of the presently disclosed software framework against a baseline MapReduce job for the PYMK task using a 30 day fixed-length sliding window. Values have been normalized against baseline. The two pass V1 jobs store a list of dest IDs in the intermediate state for each src. The two pass V2 jobs instead store a list of (dest,count) pairs for each src. In each case two variants have been tested. In one case the job of the presently disclosed software framework reuses the previous output (RO) and in the other case the job does not (NR). For total task time in FIG. 9A, jobs of the presently disclosed software framework consistently perform better than baseline. There is not a substantial difference for the (RO) jobs between the two versions. Each average about 40% of the total task time of baseline. The (NR) job for Two Pass V2 however performs better than the (NR) for Two Pass V1, being closer in performance to the (RO) job. For the wall clock time in FIG. 9B, the jobs of the presently disclosed software framework consistently have a higher wall clock time than baseline. The (RO) perform the best, having about a 40% higher wall clock time. This contrasts with the results for the total task time, where the jobs of the presently disclosed software framework consistently performed better.

This suggests that aggregation is effective for this task in reducing the amount of data. The other interesting observation is that for the second variation the performance of the two jobs is pretty similar. Considering just total task time, this implies that once the intermediate data is aggregated there is only a small benefit in reusing the previous output for this task.

Comparing the two variations in FIG. 9A, another observation is that if the previous output is reused there is little difference in performance between the two variations. That is, once previous output is being reused, there is no noticeable impact on total task time by having the intermediate data be aggregated. It is encouraging though that we can get close to the performance of reusing the output simply by aggregating the intermediate data, as not all problems are suited for reusing the previous output. Another benefit of aggregating the intermediate data is that it reduces storage costs. For the first variation, the storage costs are increased by about 185%. But for the second variation storage costs are increased by 160%.

FIG. 9B presents comparisons of the wall clock times for the jobs of the presently disclosed software framework variations against the baseline MapReduce job. All the jobs of the presently disclosed software framework consistently had higher wall clock times than the baseline job. Among these, the jobs which reused the previous output had the best wall clock times. This contrasts with the results for total task time, which showed a significant improvement for the jobs of the presently disclosed software framework. It also contrasts with the results of the Weibo benchmarks. The difference between the Weibo and PYMK benchmarks however is that the latter ran on a cluster with hundreds of machines, which allowed it to achieve much better parallelism. Likewise the jobs' resource requirements were not high enough that the jobs had to wait for slots to free up in the cluster. As a result there were no gains in wall clock time for jobs of the presently disclosed software framework for the PYMK task. The wall clock time actually increases because the jobs of the presently disclosed software framework must execute two MapReduce passes serially, the first to store the intermediate state and the second to produce the final output. The jobs of the presently disclosed software framework which reuse output reduce total task time by about 60% over baseline. However the wall clock time increases by about 40%. Therefore we have a tradeoff between total task time and wall clock time for the jobs of the presently disclosed software framework in this particular case.

One point to consider though is that reducing the total task time reduces the load on the cluster, which in turn improves cluster throughput. This may yield better wall clock time when there are many tasks running in parallel and not enough slots to execute them. Reducing the number of tasks which are required will result in jobs completing more quickly in this situation. We saw this with the Weibo benchmark where there were only two map slots available.

### Conclusion

Jobs of the presently disclosed software framework significantly reduced the total task time for sufficiently sized fixed-length sliding windows, with up to about a 60% reduction in some tests we performed. Reductions in total task time translates to more efficient utilization of a MapReduce cluster, yielding higher overall throughput. Wall clock time may either increase or decrease when using jobs of the presently disclosed software framework for fixed-length sliding windows, depending on a number of factors. Wall clock time may naturally increase due to the fact that jobs of the presently disclosed software framework uses two MapReduce jobs run sequentially for fixed-length sliding windows. Despite this the jobs of the presently disclosed software framework may finish more quickly than the corresponding basic MapReduce implementation if cluster resources are strained, as subsequent runs of jobs of the presently disclosed software framework will require fewer task slots than the basic MapReduce job.

### Example Methods and Systems

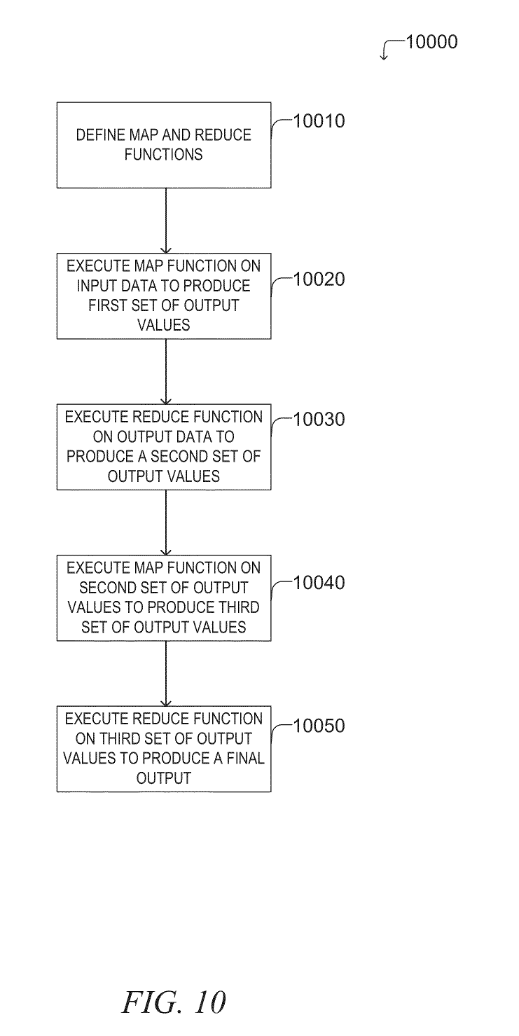

FIG. 10 shows an example method 10000 according to some examples of the present disclosure for performing sliding window computations. The method of FIG. 10 solves a sliding window problem using a partition preserving job followed by a partition collapsing job. At operation 10010 map and reduce functions are defined or received. The Map function may perform operations such as grouping, filtering, and sorting. For example, suppose that an example task were to count the last login for users during a predetermined window of time. An example time partitioned data set might be:

Day 1: User A, login time (9:00 a.m.); User C, login time (9:02 a.m.); User B, login time (11:30 a.m.) User A, login time (12:00 p.m.); User C, login time (3:00 p.m.); User A, login time (4:00 p.m.).
Day 2: User A, login time (9:02 a.m.); User B, login time (9:30 a.m.); User B, login time (12:00 p.m.); User C, login time (3:00 p.m.).
Day 3: User A, login time (9:07 a.m.); User C, login time (10:00 a.m.).

At operation 10020, the Map function may be executed. The Map task may create the following output set by sorting the input set by user, the software framework of the presently disclosed invention may automatically add the bolded partition id to the output of the Map function:
(User A, 9:00 a.m., day 1) (User A, 12:00 p.m., day 1) (User A, 4:00 p.m., day 1) (User A, 9:02 a.m., day 2) (User A, 9:07 a.m., day 3)
(User B, 11:30 a.m., day 1) (User B, 9:30 a.m., day 2) (User B, 12:00 p.m., day 2)
(User C, 9:02 a.m., day 1) (User C, 3:00 p.m., day 1) (User C, 3:00 p.m., day 2) (User C, 10:00 a.m., day 3)

At operation 10030 the Reduce function may be executed on the first set of output values. In some examples, the Reduce function may perform a summary operation. The reduce operation may receive as input the results of the Map function and output a set of data for each of the partitions. For example, for the above Map results set, the reduce function may produce the last login time per day for each user, sorted by day:

### Day 1: (User A, 4:00 p.m., Day 1) (User B, 11:30 a.m., Day 1) (User C, 3:00 p.m., Day 1)

### Day 2: (User A, 9:02 a.m., Day 2) (User B, 12:00 p.m., Day 2) (User C, 3:00 p.m., Day 2)

### Day 3: (User A, 9:07 a.m., Day 3) (User C, 10:00 a.m., Day 3)

It can be appreciated that the Reduce operation has produced the last login times for each day for each user. By appending the partition information to each output value, reuse of previous values, whether in the append only, or fixed length sliding window is possible. Note that the software framework of the present disclosure automatically tracks the partition so that the reduce function defined by the user need not worry about this. This is different than the standard Reduce function of the standard MapReduce framework in that the output, rather than the last login time for each user for all days, is only the last login time of each user per day. Thus the Reduce operation has produced a set of output values that comprise a single output per key (e.g., per user) per partition (e.g., per day). In contrast, MapReduce produces a single output per key (e.g., per user) that reflects the last login of the user over all partitions.

Once the partition preserving job is run, the partition collapsing job is run. At operation 10040 the Map function is executed on the second set of output values to produce a third set of output values. This process takes the output data from the Reducer which is grouped by partition and groups the data according to the key. On the example data from above, the mapper would again group login events by user:

### (User A, 4:00 p.m., Day 1) (User A, 9:02 a.m., Day 2) (User A, 9:07 a.m., Day 3);

### (User B, 11:30 a.m., Day 1), (User B, 12:00 p.m., Day 2);

### (User C, 3:00 p.m., Day 1), (User C, 3:00 p.m., Day 2), (User C, 10:00 a.m., Day 3).

At operation 10050, the Reduce function may take this output and produce a final result. For example, the Reduce function may produce the last login times for each user:

### (User A, 9:07 a.m., Day 3), (User B, 12:00 p.m., Day 2), (User C, 10:00 a.m., Day 3)

Note that to utilize the above method with a fixed length sliding window, the second pass of the Map function need only to exclude the partitions which are no longer counted. For example, if the window was to exclude the first day's data, the data with a partition of “day 1” would no longer be utilized.

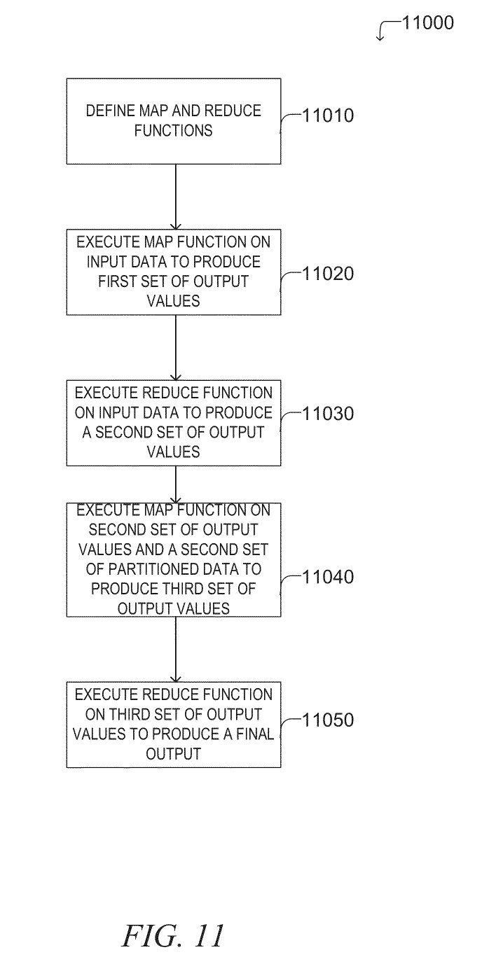

FIG. 11 shows another example method 11000 for performing sliding window computations according to some examples of the present disclosure. The method shown in FIG. 11 may utilize a single partition collapsing job. At operation 11010 map and reduce functions are defined. The Map function may perform operations such as grouping, filtering, and sorting. For example, sticking with the previous example of determining the last login for users during a predetermined window of time, the time partitioned data is:

Day 1: User A, login time (9:00 a.m.); User C, login time (9:02 a.m.); User B, login time (11:30 a.m.) User A, login time (12:00 p.m.); User C, login time (3:00 p.m.); User A, login time (4:00 p.m.).
Day 2: User A, login time (9:02 a.m.); User B, login time (9:30 a.m.); User B, login time (12:00 p.m.); User C, login time (3:00 p.m.).
Day 3: User A, login time (9:07 a.m.); User C, login time (10:00 a.m.).

At operation 11020 the Map function may be executed. The Map task may create the following output set by sorting the input set by user.
(User A, 9:00 a.m.) (User A, 12:00 p.m.) (User A, 4:00 p.m.) (User A, 9:02 a.m.) (User A, 9:07 a.m.)
(User B, 11:30 a.m.) (User B, 9:30 a.m.) (User B, 12:00 p.m.)
(User C, 9:02 a.m.) (User C, 3:00 p.m.) (User C, 3:00 p.m.) (User C, 10:00 a.m.)

At operation 11030 the reduce function may be executed on the first set of output values. The reduce operation may perform a summary operation. The reduce operation may input the results of the Map function and output a set of data for each of the keys. For example, for the above MAP results set, the reduce function may produce the last login time for each user:

### (User A, 9:07 a.m., Day 3), (User B, 12:00 p.m., Day 2), (User C, 10:00 a.m., Day 3)

It can be appreciated that the Reduce operation has produced the last login times for each user. In contrast to the partition preserving job, the first iteration is complete. Also, in contrast to standard MapReduce implementations on Hadoop, the presently disclosed software framework allows for the reuse of this result in the second iteration.

At operation 11040 the Map function is executed, taking as input the final result of the first iteration (e.g., the result of operation 11030) and a second set of partitioned input data. An example second set of data may include:

Day 4: User A, login time (9:00 a.m.); User C, login time (9:02 a.m.).

On the example data from above, the mapper would again group login events by user:

### (User A, 9:07 a.m., Day 3), (User A, 9:00 a.m., Day 4)(User B, 12:00 p.m., Day 2),

### (User C, 10:00 a.m., Day 3), (User C, 9:02 a.m., Day 4).

At operation 11050, the Reduce function may take this output and produce a final result again. For example, the Reduce function may produce the last login times for each user:

### (User A, 9:00 a.m., Day 4)(User B, 12:00 p.m., Day 2), (User C, 10:00 a.m., Day 3), (User C, 9:02 a.m., Day 4).

Note that this example showed the append only sliding window problem. For the fixed sliding window problem, the Reduce function may apply an unmerge operation which subtracts a contribution to the final result from one of the partitions.

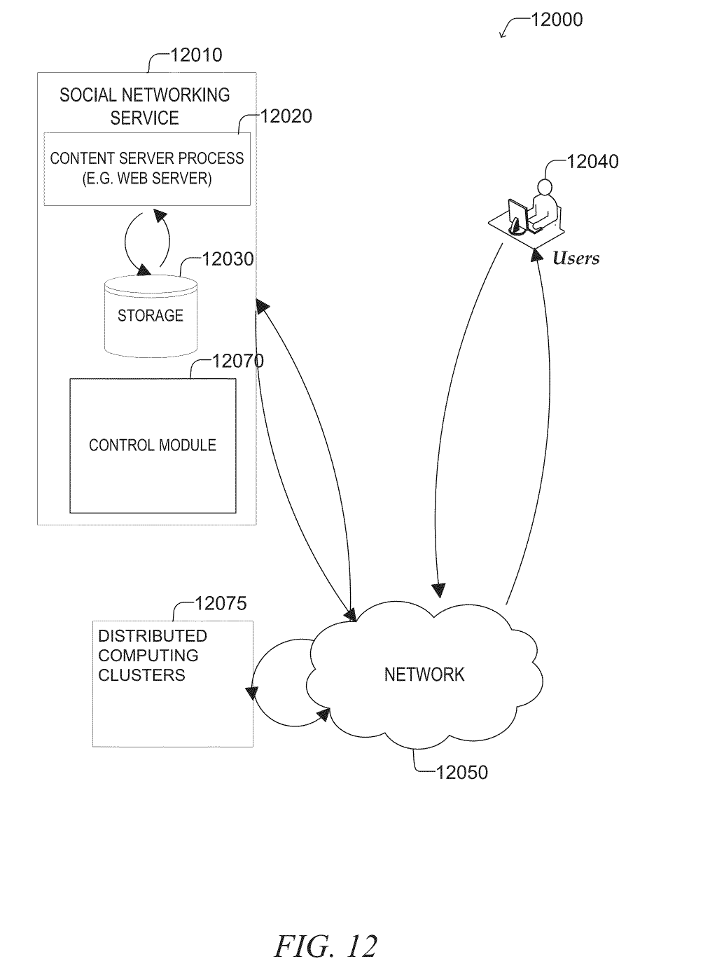

FIG. 12 shows an example system 12000 for providing a social networking service and for incremental processing on data intensive distributed applications. A social networking service is one example where incremental processing on data intensive distributed applications may be utilized. One of ordinary skill in the art with the benefit of applicants' disclosure will appreciate that other uses outside a social networking context may be utilized.

Social networking service 12010 may contain a content server process 12020. Content server process 12020 may communicate with storage 12030 and may communicate with one or more users 12040 through a network 12050. Content server process 12020 may be responsible for the retrieval, presentation, and maintenance of member profiles stored in storage 12030. Content server process 12020 in one example may include or be a web server that fetches or creates internet web pages. Web pages may be or include Hyper Text Markup Language (HTML), eXtensible Markup Language (XML), JavaScript, or the like. The web pages may include portions of, or all of, a member profile at the request of users 12040. Users 12040 may include one or more members, prospective members, or other users of the social networking service 12040. Users 12040 access social networking service 12010 using a computer system through a network 12050. The network may be any means of enabling the social networking service 12010 to communicate data with users 12040. Example networks 12050 may be or include portions of: the Internet, a Local Area Network (LAN), a Wide Area Network (WAN), wireless network (such as a wireless network based upon an IEEE 802.11 family of standards), a Metropolitan Area Network (MAN), a cellular network, or the like.

Control module 12070 may receive the definitions of the Map, Reduce, Merge, and Unmerge functions and may communicate with distributed computing clusters 12075 across network 12050. Control module 12070 may control the submission, execution of (including the definition of the Map and Reduce functions), and receipt of results of jobs submitted to the distributed computing clusters 12075. Control module may select the relevant data from data storage 12030 and may submit that data to distributed computing clusters 12075 for processing. Distributed computing clusters 12080 may execute Map and Reduce functions in parallel across a large number of processing nodes and return the output to the control module 12070. In some examples, the distributed computing clusters 12075 may be part of the social networking service 12010.

### Example Machine Implementation

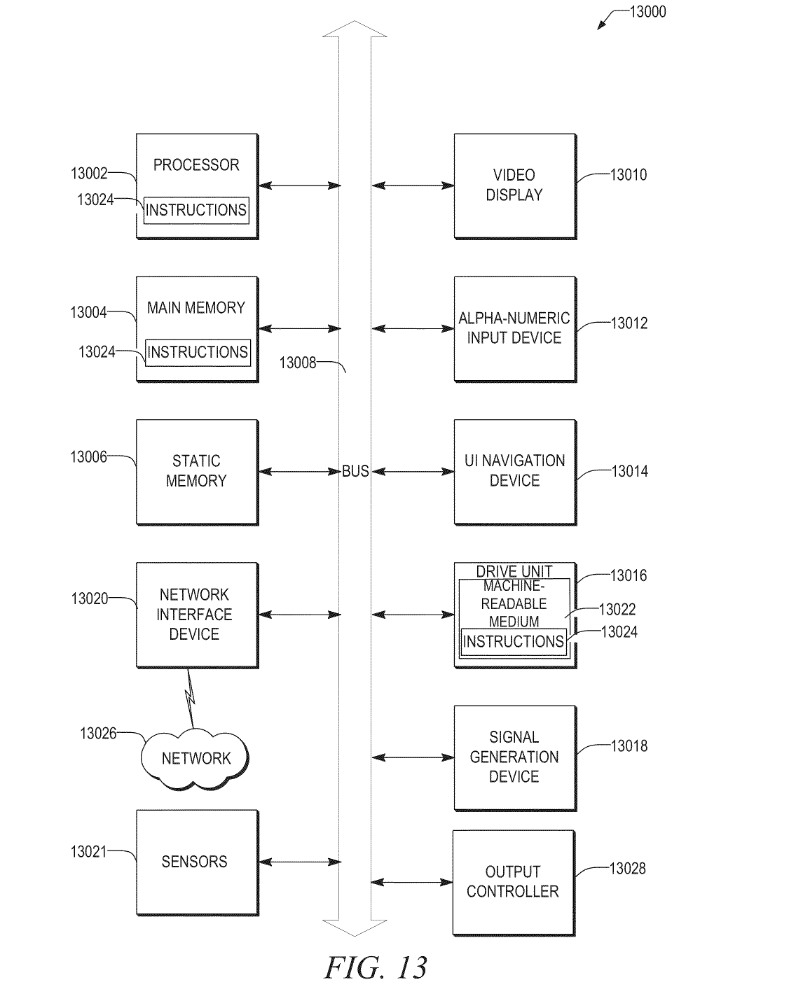

FIG. 13 illustrates a block diagram of an example machine 13000 upon which any one or more of the techniques (e.g., methodologies) discussed herein may perform. In alternative embodiments, the machine 13000 may operate as a standalone device or may be connected (e.g., networked) to other machines. In a networked deployment, the machine 13000 may operate in the capacity of a server machine, a client machine, or both in server-client network environments. In an example, the machine 13000 may act as a peer machine in peer-to-peer (P2P) (or other distributed) network environment. The machine 13000 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 13000 may include a hardware processor 13002 (e.g., a central processing unit (CPU), a graphics processing unit (GPU), a hardware processor core, or any combination thereof), a main memory 13004 and a static memory 13006, some or all of which may communicate with each other via an interlink (e.g., bus) 13008. The machine 13000 may further include a display unit 13010, an alphanumeric input device 13012 (e.g., a keyboard), a UI navigation device 13014 (e.g., a mouse). In an example, the display unit 13010, alphanumeric input device 13012 and UI navigation device 13014 may be a touch screen display. The machine 13000 may additionally include a storage device (e.g., drive unit) 13016, a signal generation device 13018 (e.g., a speaker), a network interface device 13020, and one or more sensors 13021, such as a global positioning system (GPS) sensor, compass, accelerometer, or other sensor. The machine 13000 may include an output controller 13028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 13016 may include a machine readable medium 13022 on which is stored one or more sets of data structures or instructions 13024 (e.g., software) embodying or utilized by any one or more of the techniques or functions described herein. The instructions 13024 may also reside, completely or at least partially, within the main memory 13004, within static memory 13006, or within the hardware processor 13002 during execution thereof by the machine 13000. In an example, one or any combination of the hardware processor 13002, the main memory 13004, the static memory 13006, or the storage device 13016 may constitute machine readable media.

While the machine readable medium 13022 is illustrated as a single medium, the term “machine readable medium” may include a single medium or multiple media (e.g., a centralized or distributed database, and/or associated caches and servers) configured to store the one or more instructions 13024.

The term “machine readable medium” may include any medium that is capable of storing, encoding, or carrying instructions for execution by the machine 13000 and that cause the machine 13000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 13024 may further be transmitted or received over a communications network 13026 using a transmission medium via the network interface device 13020 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 13020 may include one or more physical jacks (e.g., Ethernet, coaxial, or phone jacks) or one or more antennas to connect to the communications network 13026. In an example, the network interface device 13020 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 13000, and includes digital or analog communications signals or other intangible medium to facilitate communication of such software.

### Other Notes and Examples

Example 1 includes subject matter (such as a method, means for performing acts, machine readable medium including instructions that, when performed by a machine cause the machine to perform acts, or an apparatus configured to perform acts) for performing sliding window computations, comprising: defining a map function and a reduce function; on a computing cluster using a plurality of computer processors: executing the map function on a set of partitioned data to produce a set of first output values, the partitioned data including a (key,value) pair, the set of first output values including a partition identifier for each particular one of the set of first output values which identifies the partition the particular one of the set of first output values originated from; executing the reduce function on the set of first output values to create a second set of output values, the second set of output values comprising at most a single output per key per partition; executing the map function on the second set of output values to create a third set of output values, the third set of output values grouped by key; and executing the reduce function on the third set of output values to produce a final output, the final output producing a result for every key.

In example 2, the subject matter of example 1 may optionally include wherein the execution of the map and reduce functions on the computing cluster is managed by Hadoop.

In example 3, the subject matter of any one of examples 1-2 may optionally include wherein the set of partitioned data input to the map function comprises a first key-value pair (k1, v1), and wherein the first output values comprise a list of intermediate key-value pairs (k2, v2) and a partition identifier.

In example 4, the subject matter of any one of examples 1-3 may optionally include wherein the second set of output values comprises a third list of key-value pairs (k3, v3) for each partition.

In example 5, the subject matter of any one of examples 1-4 may optionally include executing the map function on both a second set of partitioned data from a newly added partition and the second set of output values to create a fourth set of output values, the fourth set of output values grouped by key; and executing the reduce function to produce a second final output, the input to the reduce function comprising the fourth set of output values, the final output producing a result for every key.

In example 6, the subject matter of any one of examples 1-5 may optionally include wherein the set of partitioned data is partitioned based upon time and corresponds to a first time range and the second set of partitioned data is partitioned based upon time and corresponds to a second time range that is later than the first time range.

In example 7, the subject matter of any one of examples 1-6 may optionally include executing the map function on both a second set of partitioned data from a newly added partition and a subset of the second set of output values to create a fourth set of output values, the fourth set of output values grouped by key, the subset of the second set of output values including less data than the second set of output values; and executing the reduce function to produce a second final output, the input to the reduce function comprising the fourth set of output values.

Example 8 includes or may optionally be combined with the subject matter of any one of examples 1-7 to include subject matter (such as a method, means for performing acts, machine readable medium include instructions that when performed by a machine causes the machine to perform acts, or an apparatus configured to perform acts) for performing sliding window computations comprising: defining a map function and a reduce function; on a computing cluster using a plurality of computer processors: executing the map function on a set of partitioned data to produce a set of first output values, the partitioned data including a (key,value) pair, the first output values sorted by key; executing the reduce function on the set of first output values to create a first final output, the first final output comprising a result for every key; executing the map function on the second output and a second set of partitioned data to produce a third set of output data sorted by key; executing the reduce function on the third set of output data to produce a second final output, the second final output comprising a result for every key.

In example 9, the subject matter of any one of examples 1-8 may optionally include, wherein the reduce function implements an unmerge function which removes a contribution from one of the first output values to the second final result.

In example 10, the subject matter of any one of examples 1-9 may optionally include wherein the execution of the map and reduce functions on the computing cluster is managed by Hadoop.

In example 11, the subject matter of any one of examples 1-10 may optionally include wherein the set of partitioned data input to the map function comprises a first key-value pair (k1, v1), and wherein the first output values comprise a list of intermediate key-value pairs (k2, v2).

In example 12, the subject matter of any one of examples 1-11 may optionally include wherein the set of partitioned data is partitioned based upon time and corresponds to a first time range and the second set of partitioned data is partitioned based upon time and corresponds to a second time range that is later than the first time range.

Example 13 includes or may optionally be combined with the subject matter of any one of examples 1-12 to include subject matter (such as a device, apparatus, or machine) for performing sliding window computations, comprising: one or more computer processors configured to include: a control module configured to: define a map function and a reduce function; and cause a computing cluster to: execute the map function on a set of partitioned data to produce a set of first output values, the partitioned data including a (key,value) pair, the set of first output values including a partition identifier for each particular one of the set of first output values which identifies the partition the particular one of the set of first output values originated from; execute the reduce function on the set of first output values to create a second set of output values, the second set of output values comprising at most a single output per key per partition; execute the map function on the second set of output values to create a third set of output values, the third set of output values grouped by key; and execute the reduce function on the third set of output values to produce a final output, the final output producing a result for every key.

In example 14, the subject matter of any one of examples 1-13 may optionally include wherein the execution of the map and reduce functions on the computing cluster is managed by Hadoop.

In example 15, the subject matter of any one of examples 1-14 may optionally include wherein the set of partitioned data input to the map function comprises a first key-value pair (k1, v1), and wherein the first output values comprise a list of intermediate key-value pairs (k2, v2) and a partition identifier.

In example 16, the subject matter of any one of examples 1-15 may optionally include wherein the second set of output values comprises a third list of key-value pairs (k3, v3) for each partition.

In example 17, the subject matter of any one of examples 1-16 may optionally include wherein the control module is configured to cause the computing cluster to: execute the map function on both a second set of partitioned data from a newly added partition and the second set of output values to create a fourth set of output values, the fourth set of output values grouped by key; and execute the reduce function to produce a second final output, the input to the reduce function comprising the fourth set of output values, the final output producing a result for every key.

In example 18, the subject matter of any one of examples 1-17 may optionally include wherein the set of partitioned data is partitioned based upon time and corresponds to a first time range and the second set of partitioned data is partitioned based upon time and corresponds to a second time range that is later than the first time range.

In example 19, the subject matter of any one of examples 1-18 may optionally include wherein the control module is configured to cause the computing cluster to: execute the map function on both a second set of partitioned data from a newly added partition and a subset of the second set of output values to create a fourth set of output values, the fourth set of output values grouped by key, the subset of the second set of output values including less data than the second set of output values; and execute the reduce function to produce a second final output, the input to the reduce function comprising the fourth set of output values.

Example 20 includes or may optionally be combined with the subject matter of any one of examples 1-19 to include subject matter (such as a device, apparatus, or machine) for performing sliding window computations, comprising one or more computer processors configured to include a control module configured to: define a map function and a reduce function; cause a computing cluster to: execute the map function on a set of partitioned data to produce a set of first output values, the partitioned data including a (key,value) pair, the first output values sorted by key; execute the reduce function on the set of first output values to create a first final output, the first final output comprising a result for every key; execute the map function on the second output and a second set of partitioned data to produce a third set of output data sorted by key; execute the reduce function on the third set of output data to produce a second final output, the second final output comprising a result for every key.

In example 21, the subject matter of any one of examples 1-20 may optionally include, wherein the reduce function implements an unmerge function which removes a contribution from one of the first output values to the second final result.

In example 22, the subject matter of any one of examples 1-21 may optionally include The system of claim 20, wherein the execution of the map and reduce functions on the computing cluster is managed by Hadoop.

In example 23, the subject matter of any one of examples 1-22 may optionally include wherein the set of partitioned data input to the map function comprises a first key-value pair (k1, v1), and wherein the first output values comprise a list of intermediate key-value pairs (k2, v2).

In example 24, the subject matter of any one of examples 1-23 may optionally include wherein the set of partitioned data is partitioned based upon time and corresponds to a first time range and the second set of partitioned data is partitioned based upon time and corresponds to a second time range that is later than the first time range.

What is claimed is:

1. A method for performing sliding window computations, the method comprising:
defining a map function and a reduce function;
on a computing cluster using a plurality of computer processors:
executing the map function on a set of partitioned data to produce a set of first output values, the partitioned data including a (key,value) pair, the set of first output values including a partition identifier for each particular one of the set of first output values which identifies the partition the particular one of the set of first output values originated from;
executing the reduce function on the set of first output values to create a second set of output values, the second set of output values comprising at most a single output per key per partition;
executing the map function on the second set of output values to create a third set of output values, the third set of output values grouped by key; and
executing the reduce function on the third set of output values to produce a final output, the final output producing a result for every key.

2. The method of claim 1, wherein the execution of the map and reduce functions on the computing cluster is managed by Hadoop.

3. The method of claim 1, wherein the set of partitioned data input to the map function comprises a first key-value pair (k1, v1), and wherein the first output values comprise a list of intermediate key-value pairs (k2, v2) and a partition identifier.

4. The method of claim 1, wherein the second set of output values comprises a third list of key-value pairs (k3, v3) for each partition.

5. The method of claim 1, comprising:
executing the map function on both a second set of partitioned data from a newly added partition and the second set of output values to create a fourth set of output values, the fourth set of output values grouped by key; and
executing the reduce function to produce a second final output, the input to the reduce function comprising the fourth set of output values, the final output producing a result for every key.

6. The method of claim 5, wherein the set of partitioned data is partitioned based upon time and corresponds to a first time range and the second set of partitioned data is partitioned based upon time and corresponds to a second time range that is later than the first time range.

7. The method of claim 1, comprising:
executing the map function on both a second set of partitioned data from a newly added partition and a subset of the second set of output values to create a fourth set of output values, the fourth set of output values grouped by key, the subset of the second set of output values including less data than the second set of output values; and
executing the reduce function to produce a second final output, the input to the reduce function comprising the fourth set of output values.

8. A method for performing sliding window computations, the method comprising:
defining a map function and a reduce function;
on a computing cluster using a plurality of computer processors:
executing the map function on a set of partitioned data to produce a set of first output values, the partitioned data including a (key,value) pair, the first output values sorted by key;
executing the reduce function on the set of first output values to create a first final output, the first final output comprising a result for every key;
executing the map function on the second output and a second set of partitioned data to produce a third set of output data sorted by key;
executing the reduce function on the third set of output data to produce a second final output, the second final output comprising a result for every key.

9. The method of claim 8, wherein the reduce function implements an unmerge function which removes a contribution from one of the first output values to the second final result.

10. The method of claim 8, wherein the execution of the map and reduce functions on the computing cluster is managed by Hadoop.

11. The method of claim 8, wherein the set of partitioned data input to the map function comprises a first key-value pair (k1, v1), and wherein the first output values comprise a list of intermediate key-value pairs (k2, v2).

12. The method of claim 8, wherein the set of partitioned data is partitioned based upon time and corresponds to a first time range and the second set of partitioned data is partitioned based upon time and corresponds to a second time range that is later than the first time range.

13. A system for performing sliding window computations, the system comprising:
one or more computer processors configured to include:
a control module configured to:
define a map function and a reduce function; and
cause a computing cluster to:
execute the map function on a set of partitioned data to produce a set of first output values, the partitioned data including a (key,value) pair, the set of first output values including a partition identifier for each particular one of the set of first output values which identifies the partition the particular one of the set of first output values originated from;
execute the reduce function on the set of first output values to create a second set of output values, the second set of output values comprising at most a single output per key per partition;
execute the map function on the second set of output values to create a third set of output values, the third set of output values grouped by key; and
execute the reduce function on the third set of output values to produce a final output, the final output producing a result for every key.

14. The system of claim 13, wherein the execution of the map and reduce functions on the computing cluster is managed by Hadoop.

15. The system of claim 13, wherein the set of partitioned data input to the map function comprises a first key-value pair (k1, v1), and wherein the first output values comprise a list of intermediate key-value pairs (k2, v2) and a partition identifier.

16. The system of claim 13, wherein the second set of output values comprises a third list of key-value pairs (k3, v3) for each partition.

17. The system of claim 13, wherein the control module is configured to cause the computing cluster to:
execute the map function on both a second set of partitioned data from a newly added partition and the second set of output values to create a fourth set of output values, the fourth set of output values grouped by key; and
execute the reduce function to produce a second final output, the input to the reduce function comprising the fourth set of output values, the final output producing a result for every key.

18. The system of claim 17, wherein the set of partitioned data is partitioned based upon time and corresponds to a first time range and the second set of partitioned data is partitioned based upon time and corresponds to a second time range that is later than the first time range.

19. The system of claim 13, wherein the control module is configured to cause the computing cluster to:
execute the map function on both a second set of partitioned data from a newly added partition and a subset of the second set of output values to create a fourth set of output values, the fourth set of output values grouped by key, the subset of the second set of output values including less data than the second set of output values; and
execute the reduce function to produce a second final output, the input to the reduce function comprising the fourth set of output values.

20. A system for performing sliding window computations, the system comprising:
one or more computer processors configured to include a control module configured to:
define a map function and a reduce function;
cause a computing cluster to:
execute the map function on a set of partitioned data to produce a set of first output values, the partitioned data including a (key,value) pair, the first output values sorted by key;
execute the reduce function on the set of first output values to create a first final output, the first final output comprising a result for every key;
execute the map function on the second output and a second set of partitioned data to produce a third set of output data sorted by key;
execute the reduce function on the third set of output data to produce a second final output, the second final output comprising a result for every key.

21. The system of claim 20, wherein the reduce function implements an unmerge function which removes a contribution from one of the first output values to the second final result.

22. The system of claim 20, wherein the execution of the map and reduce functions on the computing cluster is managed by Hadoop.

23. The system of claim 20, wherein the set of partitioned data input to the map function comprises a first key-value pair (k1, v1), and wherein the first output values comprise a list of intermediate key-value pairs (k2, v2).

24. The system of claim 20, wherein the set of partitioned data is partitioned based upon time and corresponds to a first time range and the second set of partitioned data is partitioned based upon time and corresponds to a second time range that is later than the first time range.
